(19) United States
(12) Patent Application Publication
(10) Pub. No.: US 2023/0208606 A1
(43) Pub. Date: Jun. 29, 2023

(54) METHODS AND APPARATUSES FOR DEMODULATION REFERENCE SIGNAL CONFIGURATIO

(71) Applicant: NEC Corporation, Tokyo (JP)

(72) Inventors: Yukai GAO, Beijing (CN); Gang Wang, Beijing (CN)

(73) Assignee: NEC Corporation, Tokyo (JP)

(21) Appl. No.: 18/119,583

(22) Filed: Mar. 9, 2023

Related U.S. Application Data
(63) Continuation of application No. 16/763,084, filed on May 11, 2020.

(51) Int. Cl. H04L 5/10; H04L 5/00; H04W 72/044; H04W 72/1263

(52) U.S. Cl. CPC H04L 5/10; H04L 5/0051; H04L 5/0094; H04W 72/0466; H04W 72/1263

(57) ABSTRACT

Embodiments of the present disclosure relate to methods and apparatuses for Demodulation Reference Signal (DMRS) configuration. In example embodiments, a method implemented in a network device is provided. According to the method, a first configuration for DMRS transmission between the network device and a terminal device is determined. The first configuration includes first information related to the DMRS transmission and is associated with a second configuration related to transmission scheduling. Both the first information and the second configuration are indicated to the terminal device by transmitting second information on the first configuration to the terminal device.

### CROSS REFERENCE TO RELATED APPLICATIONS

This application is a Continuation of U.S. application Ser. No. 16/763,084 filed May 11, 2020, which is a National Stage of International Application No. PCT/CN2017/110722 filed Nov. 13, 2017.

### TECHNICAL FIELD

Embodiments of the present disclosure generally relate to the field of telecommunication, and in particular, to methods and apparatuses for Demodulation Reference Signal (DMRS) configuration.

### BACKGROUND

With the development of communication technologies, multiple types of services or traffic have been proposed, for example, enhanced mobile broadband (eMBB) generally requiring high data rate, massive machine type communication (mMTC) typically requiring long battery lifetime, and ultra-reliable and low latency communication (URLLC). Meanwhile, multi-antenna schemes, such as multi-Transmission and Reception Point (multi-TRP) transmission and/or multi-panel transmission, are studied for new radio access (NR).

Conventionally, a network device (for example, an eNB or a gNB) transmits a downlink DMRS to a terminal device (for example, a user equipment) in the system for channel demodulation. The terminal device may receive the downlink DMRS on allocated resources. The terminal device may also transmit an uplink DMRS to the network device on corresponding allocated resources. For indicating the allocated resources and other necessary information for the DMRSs, the network device may transmit DMRS configurations to the terminal device prior to the transmissions of the DMRSs.

In NR, different DMRS ports may be multiplexed based on Code Division Multiplexing (CDM) technology in time and/or frequency domain, and/or based on Frequency Division Multiplexing (FDM) technology. For example, a group of DMRS ports multiplexed based on CDM technology can also be referred as a “CDM group”. Moreover, front-loaded DMRS is supported for fast decoding and additional DMRSs in addition to the front-loaded DMRS are supported for high-speed/high Doppler scenario. In an OFDM-based system, for the location of the first position of the front-loaded DMRS for Physical Uplink Shared Channel (PUSCH), it has been agreed that the first OFDM symbol with respect to the scheduled data contains the first symbol of front-loaded uplink DMRS. It has also agreed that the 3^{rd} or 4^{th} symbol of a slot contains the first symbol of front-loaded DMRS. However, detailed designs for DMRS configuration have not been designed yet. With considering different cases, a scheme for DMRS configuration needs to be considered, so as to balance configuration flexibility with signaling overhead.

### SUMMARY

In general, example embodiments of the present disclosure provide methods and apparatuses for DMRS configuration.

In a first aspect, there is provided a method implemented in a network device. According to the method, a first configuration for Demodulation Reference Signal (DMRS) transmission between the network device and a terminal device is determined. The first configuration includes first information related to the DMRS transmission and is associated with a second configuration related to transmission scheduling. Both the first information and the second configuration are indicated to the terminal device by transmitting second information on the first configuration to the terminal device.

In a second aspect, there is provided a method implemented in a terminal device. According to the method, second information on a first configuration for Demodulation Reference Signal (DMRS) transmission between a network device and the terminal device is received from the network device. The first configuration includes first information related to the DMRS transmission and is associated with a second configuration related to transmission scheduling. Both the first information and the second configuration are determined at least based on the second information.

In a third aspect, there is provided a network device. The network device comprises a processor and a memory coupled to the processor. The memory stores instructions that when executed by the processor, cause the network device to performs actions. The actions comprise: determining a first configuration for Demodulation Reference Signal (DMRS) transmission between the network device and a terminal device, the first configuration including first information related to the DMRS transmission, and the first information being associated with a second configuration related to transmission scheduling; and indicating, to the terminal device, both the first information and the second configuration by transmitting second information on the first configuration to the terminal device.

In a fourth aspect, there is provided a terminal device. The terminal device comprises a processor and a memory coupled to the processor. The memory stores instructions that when executed by the processor, cause the terminal device to performs actions. The actions comprise: receiving, from a network device, second information on a first configuration for Demodulation Reference Signal (DMRS) transmission between the network device and the terminal device, the first configuration including first information related to the DMRS transmission and the first information being associated with a second configuration related to transmission scheduling; and determining, at least based on the second information, both the first information and the second configuration.

In a fifth aspect, there is provided a computer readable medium having instructions stored thereon. The instructions, when executed on at least one processor, cause the at least one processor to carry out the method according to the first aspect.

In a sixth aspect, there is provided a computer readable medium having instructions stored thereon. The instructions, when executed on at least one processor, cause the at least one processor to carry out the method according to the second aspect.

In a seventh aspect, there is provided a computer program product that is tangibly stored on a computer readable storage medium. The computer program product includes instructions which, when executed on at least one processor, cause the at least one processor to carry out the method according to the first or second aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a block diagram of a communication environment in which embodiments of the present disclosure can be implemented;

FIG. 2 illustrates processes for DMRS transmission according to some embodiments of the present disclosure;

FIG. 3 shows a flowchart of an example method 300 for DMRS configuration according to some embodiments of the present disclosure;

FIGS. 4A-4D show example configuration types for DMRS transmission;

FIG. 5 shows example DMRS configurations according to some embodiments of the present disclosure;

FIG. 6 shows example DMRS configurations according to some embodiments of the present disclosure;

FIG. 7 shows example DMRS configurations according to some embodiments of the present disclosure;

FIG. 8 shows example DMRS configurations according to some embodiments of the present disclosure;

FIGS. 9A-9B show example DMRS configurations according to some embodiments of the present disclosure;

FIG. 10 shows an example of embodiments of the present disclosure;

FIGS. 11A-11B show examples of embodiments of the present disclosure;

FIG. 12 shows an example of embodiments of the present disclosure;

FIGS. 13A-13B show examples of embodiments of the present disclosure;

FIG. 14 shows a flowchart of an example method 1400 in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UE as examples of the terminal device.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Communication discussed in the present disclosure may conform to any suitable standards including, but not limited to, New Radio Access (NR), Long Term Evolution (LTE),

LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

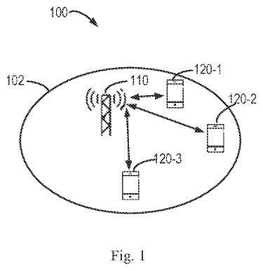

FIG. 1 shows an example communication network 100 in which embodiments of the present disclosure can be implemented. The network 100 includes a network device 110 and three terminal devices 120-1 and 120-3 (collectively referred to as terminal devices 120 or individually referred to as terminal device 120) served by the network device 110. The coverage of the network device 110 is also called as a cell 102. It is to be understood that the number of base stations and terminal devices is only for the purpose of illustration without suggesting any limitations. The network 100 may include any suitable number of base stations and the terminal devices adapted for implementing embodiments of the present disclosure. Although not shown, it would be appreciated that there may be one or more neighboring cells adjacent to the cell 102 where one or more corresponding network devices provides service for a number of terminal device located therein.

The network device 110 may communicate with the terminal devices 120. The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In addition to normal data communications, the network device 110 may send a RS in a broadcast, multi-cast, and/or unicast manners to one or more of the terminal devices 120 in a downlink. Similarly, one or more of the terminal devices 120 may transmit RSs to the network device 110 in an uplink. As used herein, a “downlink (DL)” refers to a link from a network device to a terminal device, while an “uplink (UL)” refers to a link from the terminal device to the network device. Examples of the RS may include but are not limited to downlink or uplink Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

For example, in the case of DL DMRS transmission, the DMRS may be used by the terminal devices 120 for channel demodulation. Generally speaking, a DMRS is a signal sequence (also referred to as “DMRS sequence”) that is known by both the network device 110 and the terminal devices 120. For example, a DMRS sequence may be generated and transmitted by the network device 110 based on a certain rule and the terminal device 120 may deduce the DMRS sequence based on the same rule.

In transmission of downlink and uplink DMRSs, the network device 110 may allocate corresponding resources (also referred to as “DMRS resources”) for the transmission and/or specify which DMRS sequence is to be transmitted. In some scenarios, both the network device 110 and the terminal device 120 are equipped with multiple antenna ports (or antenna elements) and can transmit specified RS sequences with the antenna ports (antenna elements). A set of DMRS resources associated with a number of DMRS ports are also specified. A DMRS port may be referred to as a specific mapping of part or all of a DMRS sequence to one or more resource elements (REs) of a resource region allocated for RS transmission in time, frequency, and/or code domains. Such resource allocation information as well as other necessary information may be indicated to the terminal device 120 prior to the transmission of the DMRSs. For example, the DMRS configurations can be transmitted via higher layer signaling (such as Radio Resource Control (RRC) and/or Medium Access Control (MAC) Control Element (CE)) and/or dynamic signaling (such as downlink control information (DCI)) to the terminal device.

In NR, different DMRS ports may be multiplexed based on Code Division Multiplexing (CDM) technology in time and/or frequency domain, and/or based on Frequency Division Multiplexing (FDM) technology. For example, a group of DMRS ports multiplexed based on CDM technology can also be referred as a “CDM group”. Moreover, front-loaded DMRS is supported for fast decoding and additional DMRSs in addition to the front-loaded DMRS are supported for high-speed/high Doppler scenario. In an OFDM-based system, for the location of the first position of the front-loaded DMRS for Physical Uplink Shared Channel (PUSCH), it has been agreed that the first OFDM symbol with respect to the scheduled data contains the first symbol of front-loaded uplink DMRS. It has also agreed that the 3^{rd} or 4^{th} symbol of a slot contains the first symbol of front-loaded DMRS. However, detailed designs for DMRS configuration have not been designed yet. With considering different cases, a scheme for DMRS configuration needs to be considered, so as to balance configuration flexibility with signaling overhead.

In order to solve the problems above and one or more of other potential problems, a solution for DMRS configuration is provided in accordance with example embodiments of the present disclosure. With the solution, the flexibility of the DMRS configuration can be balanced with the signaling overhead for indicating the DMRS configuration.

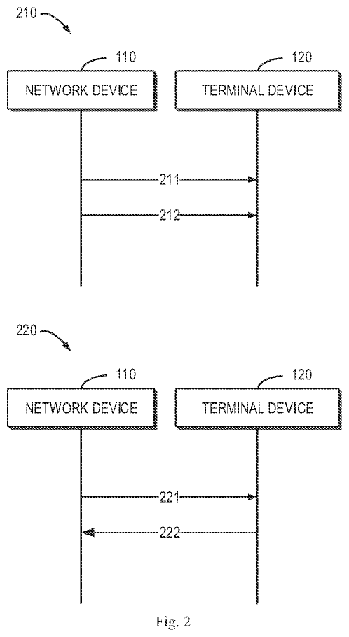

Principle and implementations of the present disclosure will be described in detail below with reference to FIGS. 2-15, in which FIG. 2 shows two processes 210 and 220 for DMRS transmission according to some embodiments of the present disclosure. For the purpose of discussion, the processes 210 and 220 will be described with reference to FIG. 1. The processes 210 and 220 may involve the network device 110 and one or more terminal devices 120 served by the network device 110.

As shown in FIG. 2, the process 210 is directed to the case of DL DMRS transmission. In one embodiment, the network device 110 may indicate (211) a DMRS configuration to a terminal device 120. The network device 120 may transmit (212) a DMRS based on the RS configuration. The terminal device 120 may receive the DMRS configuration from the network device 110, and detect the DMRS based on the received DMRS configuration. The process 220 is directed to the case of UL DMRS transmission. In another embodiment, the network device 110 may indicate (221) a DMRS configuration to the terminal device 120. The terminal device 120 may receive from the network device 110 the RS configuration, and may transmit (222) the DMRS based on the received DMRS configuration. The network device 110 may detect the DMRS based on the DMRS configuration.

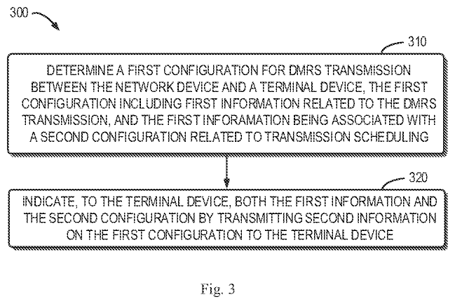

FIG. 3 shows a flowchart of an example method 300 for DMRS configuration according to some embodiments of the present disclosure. The method 300 can be implemented at the network device 110 as shown in FIG. 1. For the purpose of discussion, the method 300 will be described from the perspective of the network device 110 with reference to FIG. 1.

In act 310, the network device 110 determines a first configuration for DMRS transmission. In some embodiments, the first configuration may include first information related to the DMRS transmission. The first information may be associated with a second configuration related to transmission scheduling. In act 320, the network device 110 indicates, to the terminal device 120, both the first information and the second configuration by transmitting second information on the first configuration to the terminal device 120. Some embodiments of the present disclosure will be further described in detail as below.

In some embodiments, for example, the first information may indicate at least one of the following: one or more DMRS ports, a scrambling identity (ID) of a DMRS sequence, the number of DMRS transmission layers, a DMRS configuration pattern to be used for the DMRS transmission, and the maximum number of front-loaded DMRS symbols. The second configuration may indicate at least one of the following: presence or absence of a CDM group for rate matching, single-user scheduling, multi-user scheduling, single-user and multi-user scheduling, single-panel scheduling, multi-panel scheduling, single-Transmission and Reception Point (single-TRP) scheduling and multi-Transmission and Reception Point (multi-TRP) scheduling. In the following descriptions, the second configuration may also be referred as “an assumption” or “an additional indication” associated with the first information.

In some embodiments, for example, the network device 110 may determine a DMRS configuration table which includes a plurality of possible configurations for DMRS transmission between the network device 110 and different terminal devices. The first configuration can be allocated from the DMRS configuration table for the terminal device 120. For example, an index of the first configuration in the DMRS configuration table can be indicated to the terminal device 120 (such as, in DCI). It can be recognized that, in order to reduce the signaling overhead for indicating a DMRS configuration, the size of the DMRS configuration table needs to be reduced.

In some embodiments, each of the plurality of possible configurations in the DMRS configuration table may indicate at least one of the following: one or more DMRS ports, a scrambling ID of a DMRS sequence, the number of DMRS transmission layers, a DMRS configuration pattern to be used for DMRS transmission, the number of front-loaded DMRS symbols, presence or absence of a CDM group for rate matching, single-user scheduling, multi-user scheduling, single-user and multi-user scheduling, single-panel scheduling, multi-panel scheduling, single-TRP scheduling and multi-TRP scheduling.

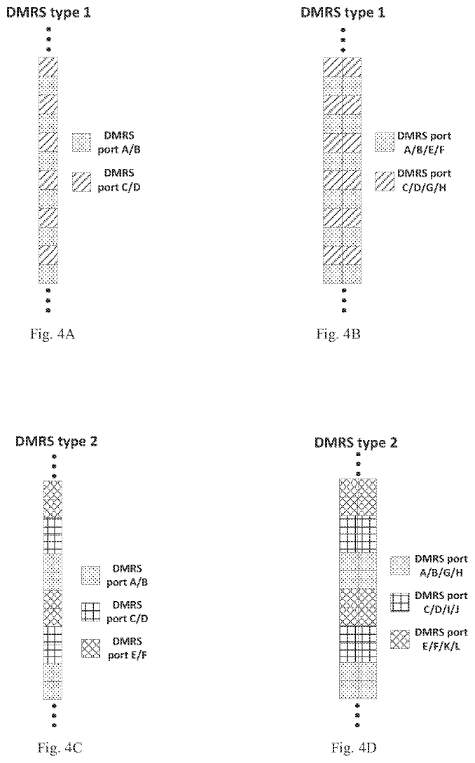

As described above, a DMRS port may belong to one CDM group and occupy several REs within one RB. For example, as agreed in 3GPP specification works, there are two types (configuration patterns) of DMRS. For DMRS type 1, one or two symbols can be supported. As shown in FIG. 4A, for DMRS type 1 associated with one symbol, up to 4 DMRS ports (represented as DMRS ports A-D) can be supported. As shown in FIG. 4B, for DMRS type 1 associated with two symbols, up to 8 DMRS ports (represented as DMRS ports A-H) can be supported. For example, for DMRS type 1, there may be two CDM groups. One CDM group may occupy REs with even indices within one RB, for example, REs 0, 2, 4, 6, 8 and 10, where the RE index starts from 0. The other CDM group may occupy REs with odd indices within on RB, for example, REs 1, 3, 5, 7, 9 and 11, where the RE index starts from 0. For DMRS type 2, one or two symbols can be supported. As shown in FIG. 4C, for DMRS type 2 associated with one symbol, up to 6 DMRS ports (represented as DMRS ports A-F) can be supported. As shown in FIG. 4D, for DMRS type 2 associated with two symbols, up to 12 DMRS ports (represented as DMRS ports A-L) can be supported. For example, for DMRS type 2, there may be three CDM groups. One CDM group may occupy REs 0, 1, 6 and 7; one CDM group may occupy REs 2, 3, 8 and 9; and one CDM group may occupy REs 4, 5, 10 and 11, where the RE index starts from 0. As shown in FIGS. 4A-4D, different fill patterns may represent different CDM groups.

In some embodiments, in the DMRS configuration table, there may be several configurations associated with a same number of DMRS transmission layers. However, these configurations may be associated with different assumptions, respectively. In some embodiments, as described above, the assumptions may include at least one of the following: presence or absence of a CDM group for rate matching, single-user scheduling, multi-user scheduling, single-user and multi-user scheduling, single-panel scheduling, multi-panel scheduling, single-Transmission and Reception Point (single-TRP) scheduling and multi-Transmission and Reception Point (multi-TRP) scheduling.

In some embodiments, for downlink and/or uplink scheduling, the scheduling may be non-slot based and/or slot-based transmission. The network device 110 may indicate one DMRS configuration from the DMRS configuration table to the terminal device 120. For example, the terminal device 120 may obtain, from the indicated DMRS configuration, the number of DMRS ports, the number of front-loaded DMRS symbols and CDM group(s) for the indicated DMRS ports. There may be one or two CDM groups which are not configured for the terminal device 120. An assumption of presence or absence of the one or two CDM groups can be associated with the indicated DMRS configuration.

In some embodiments, the DMRS configuration indicated to the terminal device 120 may be associated with an assumption of presence of a CDM group. As used herein, the presence of a CDM group may indicate that, for example, the CDM group has been configured for other terminal device(s), such as, for PDSCH and/or PUSCH transmission. Thus, rate matching around REs of the CDM group is needed for the terminal device 120. For example, these REs occupied by the CDM group may not be used by the terminal device 120 for PDSCH and/or PUSCH transmission. In some other embodiments, the DMRS configuration indicated to the terminal device 120 may be associated with an assumption of absence of a CDM group. As used herein, the absence of a CDM group may indicate that, for example, the CDM group has not been configured for other terminal device(s), such as, for PDSCH and/or PUSCH transmission. Thus, rate matching around REs of the CDM group is not needed for the terminal device 120. For example, these REs occupied by the CDM group can be used by the terminal device 120 for PDSCH and/or PUSCH transmission. For another example, these REs occupied by the CDM group may not be used by the terminal device 120 for PDSCH and/or PUSCH, and the power of the configured DMRS ports for data transmission by the terminal device 120 may be boosted, for example, by 3 dB or 6 dB. It is to be understood that the examples of the presence or absence of the CDM group are only for the purpose of illustration without suggesting any limitations to the present disclosure. In the present disclosure, rate-matching around a CDM group is illustrated as an example of the presence of the CDM group, while no rate-matching around a CDM group is illustrated as an example of the absence of the CDM group.

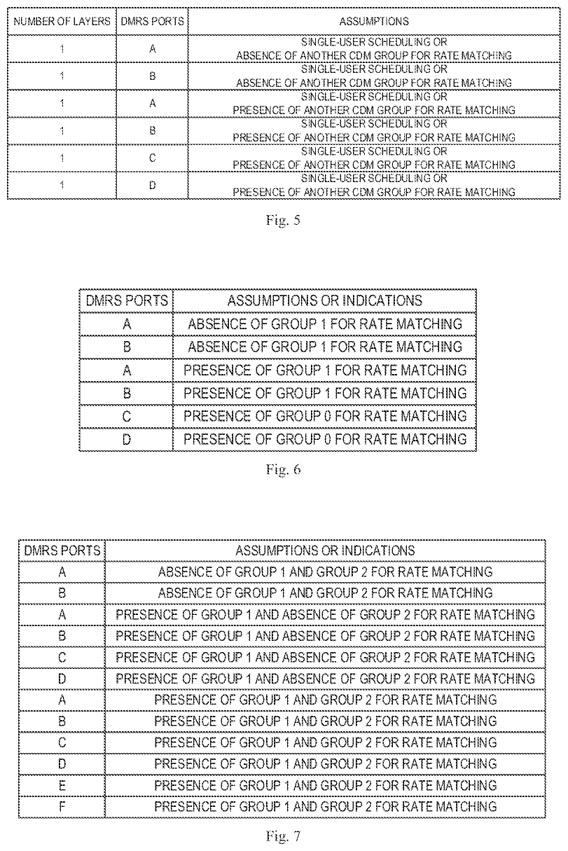

In some embodiments, a first number of configurations in the DMRS configuration table may be associated with one assumption, while a second number of configurations in the DMRS configuration table may be associated with another assumption. The first number of configurations and the second number of configurations may be associated with at least one of a same number of DMRS transmission layers, a same number of CDM groups for DMRS ports, a same number of DMRS symbols or a same DMRS configuration pattern, and the first number may be less than the second number. For example, the number of configurations associated with an assumption of single-user scheduling may be less than the number of configurations associated with an assumption of multi-user scheduling. For example, the first number of configurations associated with multi-TRP/multi-panel scheduling may be less than the number of configurations associated with single-TRP/single-panel scheduling. For example, the number of configurations associated with an assumption that another CDM group is absent for rate matching (that is, no rate matching around the other CDM group) may be less than the number of configurations associated with another assumption that another CDM group is present for rate matching. FIG. 5 shows an example of such embodiments. Specifically, FIG. 5 shows several example configurations associated with only one DMRS transmission layer. It can be seen that, in FIG. 5, the number of configurations associated with an assumption of single-user scheduling is 2, while the number of configurations associated with an assumption of single-user scheduling is 4. It is to be understood that the examples as shown in FIG. 5 are only for the purpose of illustration without suggesting any limitations to the present disclosure. The embodiments of the present disclosure are also applicable to other configurations associated with different number of DMRS transmission layers, different number of DMRS symbols and/or different DMRS configuration patterns.

In some embodiments, for DMRS type 1, the number of DMRS symbols may be 2 and the number of DMRS transmission layers may be 1. The DMRS configuration associated with absence of another CDM group for rate matching may be related to one of port A, port B, port E and port F. The DMRS configuration associated with presence of another CDM group for rate matching may be related to one of port A, port B, port C, port D, port E, port F, port G and port H.

In some embodiments, for DMRS type 1, the number of DMRS transmission layers may be 2. The configuration associated with absence of another CDM group for rate matching may be related to one of port A/B and port E/F. The configuration associated with presence of another CDM group for rate matching may be related to one of port A/B, port C/D, port E/F and port G/H. In some embodiments, for DMRS type 1, the number of DMRS transmission layers may be 3. The configuration associated with absence of another CDM group for rate matching may be related to port A/B/E. The configuration associated with presence of another CDM group for rate matching may be related to one of port A/B/E and port C/D/G. In some embodiments, for DMRS type 1, the number of DMRS layers may be 4. The configuration associated with absence of another CDM group for rate matching may be related to port A/B/E/F. The configuration associated with presence of another CDM group for rate matching may be related to one of port A/B/E/F and port C/D/G/H. In some embodiments, for DMRS type 1, the number of DMRS layers may be greater than 4. In this event, there may be no assumption on presence or absence of another CDM group for rate matching for the configurations.

In some embodiments, the assumption of presence of another CDM group for rate matching may be only available for a configuration associated with a certain number of DMRS ports, a certain number of CDM groups and/or a certain number of front-loaded DMRS symbols. For example, for DMRS type 1, if the number of front-loaded DMRS symbol is 1, only the configurations with 1 or 2 DMRS ports, and/or the configurations with DMRS ports from one CDM group may be associated with an assumption of presence of another CDM group for rate matching. For example, for a configuration with 3 or 4 DMRS ports, there may be no assumption of rate-matching around another CDM group. For example, for DMRS type 1, if the number of front-loaded DMRS symbol is 2, only the configurations with 1, 2, 3 or 4 DMRS ports and/or the configurations with DMRS ports from one CDM group may be associated with an assumption of presence of another CDM group for rate matching. For example, for a configuration associated with more than 4 DMRS ports, there may be no assumption of rate-matching around another CDM group. For example, for a configuration associated with 2, 3 or 4 DMRS ports, while these DMRS ports are from different CDM groups, there may be no assumption of rate-matching around another CDM group.

In some embodiments, for downlink or uplink transmission, the maximum number of DMRS ports, the maximum number of codewords and/or the maximum number of CDM groups may be configured to a terminal device. In some embodiments, the configuration of multi-TRP/multi-panel scheduling may be associated with a subset of the maximum number of DMRS ports, a subset of the maximum number of codewords and/or a subset of the maximum number of CDM groups indicated to the terminal device. In one embodiment, the configurations of multi-TRP/multi-panel scheduling may be only associated with more than X DMRS ports configured for the terminal device, where X is an integer. For example, X may be any of 1, 2 or 4. In one embodiment, the multi-TRP/multi-panel scheduling may be only available if DMRS ports in the configuration are from more than Y CDM groups, where Y is an integer. For example, Y may be 1. For example, for DMRS type 1 and/or type 2, multi-TRP/multi-panel scheduling may be only available if DMRS ports in the configuration are from 2 CDM groups. For example, for DMRS configuration type 2, multi-TRP/multi-panel scheduling may be only available if DMRS ports in the configuration are from 2 or 3 CDM groups. In one embodiment, the configurations of multi-TRP/multi-panel scheduling may be only associated with more than Z codewords configured for the terminal device, where Z is an integer. For example, Z may be 1. For example, for DMRS type 1 and/or type 2, the configurations of multi-TRP/multi-panel scheduling may be only available if the number of codewords configured for the terminal device is 2.

In some embodiments, for different configurations in the DMRS configuration table, the assumptions related to presence or absence of CDM group(s) for rate matching may be different. For example, if some configurations in the DMRS configuration table are associated with an assumption of no rate-matching around CDM group(s), these configurations may implicitly indicate single-user scheduling, since multi-user scheduling within one CDM group may not be enabled.

In some embodiments, in the DMRS configuration table, for the configurations with a given number of DMRS layers, a given number of front-loaded DMRS symbols and a given DMRS type, if the DMRS ports in the configurations come from one or two CDM groups, the number of configurations with DMRS ports from some CDM group(s) may be larger than the number of configurations with DMRS ports from other CDM group(s).

In some embodiments, in the DMRS configuration table, for the configurations with a given number of DMRS layers, a given number of front-loaded DMRS symbols and a given DMRS type, if DMRS ports associated with the configurations come from a same CDM group, there may be two different assumptions associated with these configurations. The first one is an assumption of presence of another CDM group for rate matching, and the second one is an assumption of no rate matching around the other CDM group. In some embodiments, the number of configurations with the first assumption may be greater than the number of configurations with the second assumption.

In some embodiments, there may be only a subset of configurations from the DMRS configuration table available for a terminal device.

In some embodiments, for downlink and/or uplink scheduling, the scheduling may be non-slot based and/or slot-based transmission. The network device 110 may indicate one DMRS configuration from the DMRS configuration table to the terminal device 120. For example, the terminal device 120 may obtain, from the indicated DMRS configuration, the number of DMRS ports, the number of front-loaded DMRS symbols and CDM group(s) for the indicated DMRS ports. Within the same CDM group(s) which is configured to the terminal device 120, there may be several DMRS ports which are not configured to the terminal device 120 for PDSCH and/or PUSCH transmission. An assumption of presence or absence of these DMRS ports can be associated with the indicated DMRS configuration.

In some embodiments, the DMRS configuration may indicate to the terminal device 120 a first subset of DMRS ports from the CDM group(s) for PDSCH and/or PUSCH transmission. For other DMRS ports (for example the second subset of DMRS ports) within the same CDM group(s), the terminal device 120 may assume them to be present for rate matching. In this event, for example, the power offset of DMRS with respect to PDSCH and/or PUSCH for the terminal device 120 may be assumed to be P₁. Alternatively or in addition, in some other embodiments, for the second subset of DMRS ports within the same CDM group(s), the terminal device 120 may assume them to be absent for rate matching. In this event, for example, the power offset of DMRS with respect to PDSCH and/or PUSCH for the terminal device 120 may be assumed to be P₂. In one embodiment, for example, P₂≥P₁. In some embodiments, the number of configurations with assumptions of presence of a DMRS port from the same CDM group(s) for rate matching may be greater than the number of configurations with assumptions of absence of a DMRS port from the same CDM group(s) for rate matching.

In some embodiments, for DMRS type 1 as described above, there may be two CDM groups, such as group 0 and group 1. For example, for DMRS type 1 associated with one symbol, group 0 may include DMRS ports A and/or B, and group 1 may include DMRS ports C and/or D. For DMRS type 1 associated with two symbols, group 0 may include DMRS ports A, B, E and/or F, and group 1 may include DMRS ports C, D, G and/or H. In one embodiment, for a configuration associated with a DMRS port from group 0, an additional indication on presence or absence of group 1 for rate matching should be included in the configuration. In one embodiment, for a configuration associated with a DMRS port from group 1, it can be assumed that group 0 is present for rate matching. For example, data cannot be transmitted in the REs of CDM group 0. In other words, if a DMRS port from group 1 is scheduled for the DMRS transmission, it can be assumed that group 0 is present for rate matching. Specially, in some embodiments, among several configurations associated with a same number of DMRS transmission layers, a same number of front-loaded DMRS symbols and/or a same number of CDM groups for the DMRS ports, the number of configurations associated with group 0 may be greater than the number of configurations associated with group 1. FIG. 6 shows an example of such embodiments. Specifically, FIG. 6 shows several example configurations for DMRS type 1 associated with one symbol. It can be seen that, in FIG. 6, the number of configurations associated with group 0 (for example, DMRS port A or B) is 4, while the number of configurations associated with group 1 (for example, DMRS port C or D) is 2. It is to be understood that the examples related to CDM groups 0 and 1 and DMRS ports A, B, C and D as shown in FIG. 6 are only for the purpose of illustration without suggesting any limitations to the present disclosure. For example, CDM groups 0 and 1 each are only illustration for the DMRS ports from a same CDM group and the DMRS ports within one CDM group may be any of the 8 orthogonal DMRS ports for type 1. The DMRS port A, B, C or D may be any of the 8 orthogonal DMRS ports for type 1 (for example, including DMRS ports A, B, C, D, E, F, G and H).

In some embodiments, one of the CDM groups may be assumed to be always present or absent for rate matching. In one embodiment, the terminal device 120 may be configured with a set of DMRS ports or at least one of the 2 CDM groups. For example, the terminal device 120 may be configured with DMRS ports from {A, B, E, F}, or configured with group 0. In this event, group 1 can be assumed to be always present or absent for rate matching. For example, for all of the configurations in the DMRS indication table, only one assumption of group 1 may be assumed, such as, either presence or absence for rate matching. For example, the terminal device 120 may be configured with DMRS ports from {C, D, G, H}, or configured with group 1 for UL transmission. In this event, group 1 can be assumed to be present for rate matching for DL transmission. As such, the total number of configurations included in the DMRS configuration table can be reduced, thereby reducing the signaling overhead for indicating one thereof

In some embodiments, for DMRS type 1, if both of the two CDM groups are available for one terminal device, a first number of configurations in the DMRS configuration table may be associated with a first assumption and a second number of configurations in the DMRS configuration table may be associated with a second assumption which may be different from the first assumption. In one embodiment, the number of CDM groups related to the first assumption may be less than the number of CDM groups related to the second assumption.

In some embodiments, for DMRS type 2 as described above, there may be three CDM groups, such as group 0, group 1 and group 2. For example, for DMRS type 2 associated with one symbol, group 0 may include DMRS ports A and/or B, group 1 may include DMRS ports C and/or D, and group 2 may include DMRS ports E and/or F. For DMRS type 2 associated with two symbols, group 0 may include DMRS ports A, B, G and/or H, group 1 may include DMRS ports C, D, I and/or J, and group 2 may include DMRS ports E, F, K and/or L.

In some embodiments, for DMRS type 2, if all of the three CDM groups are available for one terminal device, a first number of configurations in the DMRS configuration table may be associated with a first assumption, a second number of configurations in the DMRS configuration table may be associated with a second assumption and a third number of configurations in the DMRS configuration table may be associated with a third assumption, where the first, second and third assumptions are at least partially different from each other. In one embodiment, the number of CDM groups related to the first assumption may be less than the number of CDM groups related to the second assumption, and/or the number of CDM groups related to the second assumption may be less than the number of CDM groups related to the third assumption.

In some embodiments, for DMRS type 1, configurations in the DMRS configuration table may be associated with a given number of DMRS layers and/or a given number of front-loaded DMRS symbols. If DMRS ports for a certain configuration are from one CDM group, the number of configurations associated with DMRS ports from CDM group 0 may be greater than the number of configurations associated with DMRS ports from CDM group 1.

In some embodiments, for DMRS type 1, if only one CDM group is available for one terminal device, the available DMRS configurations for the terminal device may be associated with only one assumption. For example, the only assumption may be either presence or absence of the other CDM group for rate matching.

In some embodiments, for DMRS type 1, configurations in the DMRS configuration table may be associated with a given number of DMRS layers and/or a given number of front-loaded DMRS symbols. If DMRS ports for a certain configuration are from one CDM group, the number of configurations associated with an assumption of no rate matching around another CDM group may be less than the number of configurations associated with an assumption of presence of another CDM group for rate matching.

In some embodiments, for DMRS type 1, configurations in the DMRS configuration table may be associated with a given number of DMRS layers and/or a given number of front-loaded DMRS symbols. If DMRS ports for a certain configuration are from one CDM group, for the configurations with an assumption of no rate matching around another CDM group, DMRS ports associated with these configurations may come from a same CDM group. For example, the only CDM group may be either group 0 or group 1. For the configurations with an assumption of presence of another CDM group for rate matching, DMRS ports associated with some of these configurations may come from CDM group 0, and DMRS ports associated with the other of these configurations may come from CDM group 1. That is, both of the two CDM groups may be available.

In some embodiments, for DMRS type 1, if configurations are associated with an assumption of no rate matching around another CDM group, DMRS ports for these configurations may come from a same CDM group. In some embodiments, whether the DMRS ports are from group 0 or group 1 may be implicitly indicated by a parameter. For example, the parameter may be at least one of cell ID, virtual cell ID, scrambling ID, and etc. For example, some values of the parameter may implicitly indicate that the DMRS ports are from group 0, while other values of the parameter may implicitly indicate that the DMRS ports are from group 1. For example, even and odd values of the parameter can implicitly indicate different groups respectively.

In some embodiments, for DMRS type 2, there may be three CDM groups, such as group 0, group 1 and group 2. In one embodiment, for a configuration associated with a DMRS port from group 0, an additional indication on presence or absence of group 1 and group 2 for rate matching should be included in the configuration. In one embodiment, for a configuration associated with a DMRS port from group 1, it can be assumed that group 0 is present for rate matching. Further, an additional indication on presence or absence of group 2 for rate matching should be included in the configuration. In one embodiment, for a configuration associated with a DMRS port from group 2, it can be assumed that group 1 and group 0 are present for rate matching. In other words, if a DMRS port from group 2 is scheduled for the DMRS transmission, it can be assumed that group 1 and group 0 are present for rate matching. Specially, in some embodiments, among several configurations associated with a same number of DMRS transmission layers, the number of configurations associated with group 0 may be greater than the number of configurations associated with group 1 and/or group 2, and/or the number of configurations associated with group 1 may be greater than the number of configurations associated with group 2. FIG. 7 shows an example of such embodiments. Specifically, FIG. 7 shows several example configurations for DMRS type 2 associated with one symbol. It can be seen that, in FIG. 7, the number of configurations associated with group 0 (for example, DMRS port A or B) is 6, the number of configurations associated with group 1 (for example, DMRS port C or D) is 4, while the number of configurations associated with group 2 (for example, DMRS port E or F) is 4. It is to be understood that the examples related to CDM groups 0, 1 and 2 and DMRS ports A, B, C, D, E and F as shown in FIG. 7 are only for the purpose of illustration without suggesting any limitations to the present disclosure. For example, CDM groups 0, 1 and 2 each are only illustration for the DMRS ports from a same CDM group and the DMRS ports within one CDM group may be any of the 12 orthogonal DMRS ports for type 2. The DMRS port A, B, C, D, E or F may be any of the 12 orthogonal DMRS ports for type 2 (for example, including DMRS ports A, B, C, D, E, F, G, H, I, J, K and L).

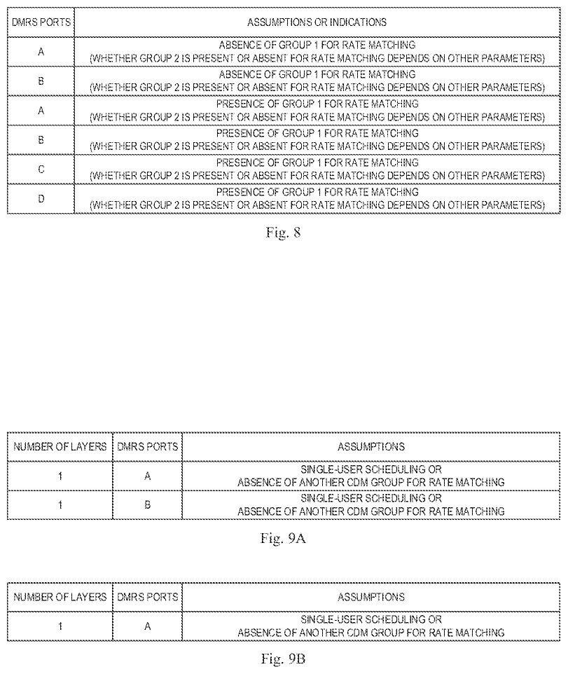

In some embodiments, some of the CDM groups may be assumed to be always present or absent for rate matching. In one embodiment, the terminal device 120 may be configured with a set of DMRS ports or at least one of the 3 CDM groups. For example, the terminal device 120 may be configured with DMRS ports from {A, B, C, D, G, H, I, J}, or configured with groups 0 and 1. In this event, group 2 can be assumed to be always present or absent for rate matching. For example, for all of the configurations in the DMRS indication table, only one assumption may be associated with group 2, such as, either presence or absence for rate matching. For example, the terminal device 120 may be configured with DMRS ports from {E, F, K, L}, or configured with group 2 for UL transmission. In this event, group 2 can be assumed to be present for rate matching for DL transmission. As such, the total number of configurations included in the DMRS configuration table can be reduced, thereby reducing the signaling overhead for indicating one thereof. FIG. 8 shows an example of such embodiments. Specifically, FIG. 8 shows several example configurations for DMRS type 2 associated with one symbol and one DMRS layer. It is to be understood that the examples as shown in FIG. 8 are only for the purpose of illustration without suggesting any limitations to the present disclosure.

In some embodiments, for DMRS type 2, all of the three CDM groups may be available for one terminal device. Configurations in the DMRS configuration table may be associated with a given number of DMRS layers and/or a given number of front-loaded DMRS symbols. If DMRS ports for a certain configuration are from one or two CDM groups, the number of configurations associated with DMRS ports from CDM group 0 may be greater than the number of configurations associated with DMRS ports from CDM group 1. Alternatively or in addition, the number of configurations associated with DMRS ports from CDM group 1 may be greater than the number of configurations associated with DMRS ports from CDM group 2. Alternatively or in addition, the number of configurations associated with DMRS ports from CDM group 0 may be greater than the number of configurations associated with DMRS ports from CDM group 2. Alternatively or in addition, the number of configurations associated with DMRS ports from CDM groups 0 and 1 may be greater than the number of configurations associated with DMRS ports from CDM groups 1 and 2.

In some embodiments, for DMRS type 2, two CDM groups may be available for one terminal device. For example, the two available CDM groups are group 0 and group 1. Configurations in the DMRS configuration table may be associated with a given number of DMRS layers and/or a given number of front-loaded DMRS symbols. If DMRS ports for a certain configuration are from one CDM group, the number of configurations associated with DMRS ports from CDM group 0 may be greater than the number of configurations associated with DMRS ports from CDM group 1.

In some embodiments, for DMRS type 2, only one CDM group may be available for one terminal device. The available DMRS configurations for the UE may be associated with only one assumption. For example, the assumption may be either presence or absence of another CDM group for rate matching.

In some embodiments, for DMRS type 2, all of the three CDM groups may be available for one terminal device. Configurations in the DMRS configuration table may be associated with a given number of DMRS layers and/or a given number of front-loaded DMRS symbols. In one embodiment, if DMRS ports for a certain configuration are from one CDM group, the number of configurations associated with an assumption of no rate matching around other two CDM groups may be less than the number of configurations with an assumption of presence of other two CDM groups for rate matching. Alternatively or in addition, the number of configurations associated with an assumption of no rate matching around one of the other two CDM groups may be less than the number of configurations with an assumption of presence of both of the other two CDM groups for rate matching. In another embodiment, if DMRS ports for a certain configuration are from two CDM groups, the number of configurations with an assumption of absence of a third CDM group for rate matching may be less than the number of configurations with an assumption of presence of a third CDM group for rate matching.

In some embodiments, for DMRS type 2, two of the three CDM groups may be available for one terminal device. Configurations in the DMRS configuration table may be associated with a given number of DMRS layers and/or a given number of front-loaded DMRS symbols. If DMRS ports for a certain configuration are from one CDM group, the number of configurations associated with an assumption of no rate matching around another CDM group may be less than the number of configurations with an assumption of presence of another CDM group for rate matching.

In some embodiments, for DMRS type 2, all of the three CDM groups may be available for one terminal device. Configurations in the DMRS configuration table may be associated with a given number of DMRS layers and/or a given number of front-loaded DMRS symbols. If DMRS ports for a certain configuration are from one CDM group, for configurations associated with an assumption of no rate matching around the other two CDM groups, DMRS ports for these configurations may be from a same CDM group. For example, the CDM group may be one of group 0, group 1 or group 2. For configurations associated with an assumption that one of the other two CDM groups is present for rate matching, some of these configurations may be associated with DMRS ports from one of the three CDM group, while the other of these configurations may be associated with DMRS ports from another one of the three CDM groups. That is, DMRS ports for these configurations may come from only two of the three CDM groups. For configurations associated with an assumption that both of the other two CDM groups are present for rate matching, some of these configurations may be associated with DMRS ports from CDM group 0, some of these configurations may be associated with DMRS ports from CDM group 1, while the other of these configurations may be associated with DMRS ports from CDM group 2.

In some embodiments, for DMRS type 2, all of the three CDM groups may be available for one terminal device. Configurations in the DMRS configuration table may be associated with a given number of DMRS layers and/or a given number of front-loaded DMRS symbols. If DMRS ports for a certain configuration are from one CDM group, there may be two assumptions associated with these configurations. One is both of the other two CDM groups are present for rate matching, and the other is both of the other two CDM groups are absent for rate matching.

In some embodiments, for DMRS type 2, all of the three CDM groups may be available for one terminal device. Configurations in the DMRS configuration table may be associated with a given number of DMRS layers and/or a given number of front-loaded DMRS symbols. If DMRS ports for a certain configuration are from two CDM groups, there may be two assumptions associated with these configurations. One is the remaining CDM group is present for rate matching, and the other is the remaining CDM group is absent for rate matching.

In some embodiments, for DMRS type 1, all of the three CDM groups may be available for one terminal device. If configurations with an assumption of no rate matching around the other two CDM groups, DMRS ports for these configurations may be from a same CDM group. In some embodiments, whether the DMRS ports are from group 0, group 1 or group 2 may be implicitly indicated by a parameter. For example, the parameter may be at least one of cell ID, virtual cell ID, scrambling ID, and etc. For example, some values of the parameter may implicitly indicate that the DMRS ports may be from group 0, some values of the parameter may implicitly indicate that the DMRS ports may be from group 1, while the other values of the parameter may implicitly indicate that the DMRS ports may be from group 2. For example, the result of the value of the parameter modulo 3 can be used to indicate the CDM group including the DMRS ports.

In some embodiments, for DMRS type 2, two of the three CDM groups may be available for one terminal device, such as, CDM groups 0 and 1. Configurations in the DMRS configuration table may be associated with a given number of DMRS layers and/or a given number of front-loaded DMRS symbols. If DMRS ports for a certain configuration are from one CDM group, for configurations associated with an assumption of no rate matching around another CDM group, DMRS ports for these configurations may be from a same CDM group. For example, the only CDM group may be either group 0 or group 1. For configurations associated with an assumption of presence of another CDM group for rate-matching, some of these configurations may be associated with DMRS ports from CDM group 0, and the other of these configurations may be associated with DMRS ports from CDM group 1.

In some embodiments, for DMRS type 2, two of the three CDM groups may be available for one terminal device, such as, CDM groups 0 and 1. If configurations are associated with an assumption of no rate matching around another CDM group, DMRS ports for these configurations may come from a same CDM group. In some embodiments, whether the DMRS ports are from group 0 or group 1 may be implicitly indicated by a parameter. For example, the parameter may be at least one of cell ID, virtual cell ID, scrambling ID, and etc. For example, some values of the parameter may implicitly indicate that that the DMRS ports are from group 0, while the other values of the parameter implicitly indicate that the DMRS ports are from group 1. For example, even and odd values of the parameter can implicitly indicate different groups respectively.

In some embodiments, for DMRS type 2, the number of DMRS symbols may be 2 and the number of DMRS layers may be 1. A configuration in the DMRS configuration table associated with no rate matching around another CDM group may be related to port A, port B, port G or port H. Alternatively or in addition, a configuration in the DMRS configuration table associated with presence of other two CDM groups for rate matching may be related to port A, port B, port C, port D, port E, port F, port G, port H, port I, port J, port K or port L. Alternatively or in addition, a configuration in the DMRS configuration table associated with presence of one of other two CDM groups for rate matching may be related to port A, port B, port C, port D, port G, port H, port I or port J.

In some embodiments, for DMRS type 2, the number of DMRS symbols may be 2. A configuration in the DMRS configuration table associated with no rate matching around the other two CDM groups may be related to port A/B or port G/H. Alternatively or in addition, a configuration in the DMRS configuration table associated with presence of one of the other two CDM groups for rate matching may be related to port A/B, port G/H, port C/D or port W. Alternatively or in addition, a configuration in the DMRS configuration table associated with presence of both of the other two CDM groups for rate matching may be related to port A/B, port C/D, port E/F, port G/H, port I/J or port K/L. In some embodiments, for DMRS type 2, the number of DMRS symbols may be 3. A configuration in the DMRS configuration table associated with no rate matching around both of the other two CDM groups may be related to port A/B/G. Alternatively or in addition, a configuration in the DMRS configuration table associated with presence of one of the other two CDM groups for rate matching may be related to port A/B/G or port C/D/I. Alternatively or in addition, a configuration in the DMRS configuration table associated with presence of the other two CDM groups for rate matching may be related to port A/B/G, port C/D/I or port E/F/K. In some embodiments, for DMRS type 2, the number of DMRS layers may be 4. A configuration in the DMRS configuration table associated with no rate matching around both of the other two CDM groups may be related to port A/B/G/H. Alternatively or in addition, a configuration in the DMRS configuration table associated with presence of one of the other two CDM groups for rate matching may be related to port A/B/G/H or port C/D/I/J. Alternatively or in addition, a configuration in the DMRS configuration table associated with presence both of the other two CDM groups for rate matching may be related to port A/B/G/H, port C/D/I/J or port E/F/K/L. In some embodiments, for DMRS type 2, the number of DMRS layers may be greater than 4, DMRS ports for one configuration associated with presence of a third CDM group for rate matching may be the same with those for another configuration associated with no rate matching around the third CDM group. In some embodiments, for DMRS type 2, if the number of DMRS layers is greater than 4, there may be only one assumption associated with the of configurations, such as, either presence or absence of the third CDM group for rate matching.

In some embodiments, the assumption of presence of another CDM group for rate matching may be only available for a configuration associated with a certain number of DMRS ports, a certain number of CDM groups and/or a certain number of front-loaded DMRS symbols. For example, for DMRS type 2, if the number of front-loaded DMRS symbol is 1, only the configurations with 1 or 2 DMRS ports, and/or the configurations with DMRS ports from one CDM group may be associated with an assumption of presence of the other two CDM groups for rate matching. Alternatively or in addition, only the configurations with 1, 2, 3 or 4 DMRS ports, and/or the configurations with DMRS ports from one or two CDM groups may be associated with an assumption of presence of only one of the other two CDM groups for rate matching. For example, if the number of DMRS ports is 5 or 6, there may be no assumption that another CDM group is present for rate matching. For example, for DMRS type 2, if the number of front-loaded DMRS symbol is 2, only the configurations with 1, 2, 3 or 4 DMRS ports, and/or the configurations with DMRS ports from one CDM group may be associated with an assumption that both of the other two CDM groups are present for rate matching, and/or an assumption that one of the other two CDM groups is present for rate matching. For example, if the number of DMRS ports is greater than 4, there may be only one assumption that a third CDM groups is present or absent for rate matching. For example, if the number of DMRS ports is 2, 3 or 4 and the DMRS ports are from different CDM groups, there may be only one assumption that a third CDM groups is present or absent for rate matching.

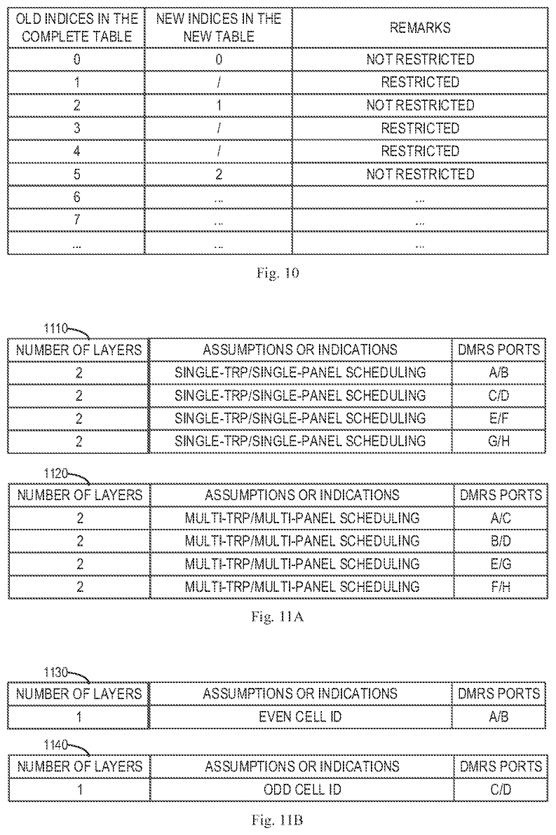

In some embodiments, in the DMRS configuration table, there may be a plurality of configurations associated with a same number of DMRS transmission layers (such as, one layer or two layers). These configurations may also be associated with an assumption that other CDM groups are absent for rate matching. In some embodiments, in the DMRS configuration table, for configurations associated with a given number of front-loaded DMRS symbols, a given number of DMRS transmission layers, and a given DMRS configuration type, all of DMRS ports associated with these configurations with the assumption that other CDM groups are absent for rate matching may from one or two CDM groups. FIG. 9A shows an example of such embodiments. Specifically, FIG. 9A shows several example configurations for DMRS type 1 associated with one symbol. Two example configurations as shown in FIG. 9A each are associated with one DMRS transmission layer as well as an assumption of single-user scheduling or no rate matching around other CDM groups.

Alternatively or in addition, in some embodiments, in the DMRS configuration table, there may be no more than one configuration associated with a given number of DMRS transmission layers (such as, one layer, two layers, three layers or four layers). These configurations may also be associated with an assumption that other CDM groups are absent for rate matching. In some embodiments, in the DMRS configuration table, for configurations associated with a given number of front-loaded DMRS symbols, a given number of DMRS transmission layers and a given DMRS configuration type, there may be no more than one configuration associated with the assumption of no rate matching around other CDM groups. FIG. 9B shows an example of such embodiments. Specifically, FIG. 9B shows one example configuration for DMRS type 1 associated with one symbol. The example configuration as shown in FIG. 9B is associated with one DMRS transmission layer as well as an assumption of single-user scheduling or presence of other CDM groups for rate matching.

In some embodiments, configurations in the DMRS configuration table may be associated with a given number of front-loaded DMRS symbols, a given number of DMRS transmission layers, and a given DMRS configuration type. DMRS port(s) from only one CDM group may be configured for one terminal device for PDSCH and/or PUSCH transmission. In some embodiments, if multi-user scheduling within a CDM group is not supported for a configuration with an assumption of no rate matching around another CDM group, the number of available configurations may be no greater than one. In some embodiments, if multi-user scheduling within a CDM group is supported for a configuration with an assumption of no rate matching around another CDM group, the number of available configurations for 1 symbol front-loaded DMRS may be no greater than two, and/or the number of available configurations for 2 symbols front-loaded DMRS may be no greater than four.

In some embodiments, for DMRS type 2, configurations in the DMRS configuration table may be associated with a given number of front-loaded DMRS symbols, a given number of DMRS transmission layers, and a given DMRS configuration type. DMRS port(s) from only one CDM group may be configured for one terminal device for PDSCH and/or PUSCH transmission. In some embodiments, if multi-user scheduling within a CDM group is not supported for a configuration with an assumption of no rate matching around one of the other two CDM group(s), the number of available configurations may be no greater than two. In some embodiments, if multi-user scheduling within a CDM group is not supported for a configuration with an assumption of not rate matching around one of the other two CDM groups, the number of available configurations for 1 symbol front-loaded DMRS may be no greater than four, and/or the number of available configurations for 2 symbols front-loaded DMRS may be no greater than eight.

In some embodiments, for non-slot based uplink and/or downlink transmission with a certain number of symbols, there may be some restrictions on the DMRS configurations and/or assumptions on the DMRS configurations. In some embodiments, at least for non-slot based uplink and/or downlink transmission with a certain number of symbols, the number of DMRS ports and/or the number of CDM groups for one terminal device may be limited. For example, for non-slot based transmission with 2, 4 or 7 symbols and for DMRS type 1, the maximum number of DMRS ports for one terminal device may be 4, and/or the maximum number of DMRS CDM groups for one terminal device may be 1. For example, for non-slot based transmission with 2, 4 or 7 symbols and for DMRS type 2, the maximum number of DMRS ports for one terminal device may be 4 or 8, and/or the maximum number of DMRS CDM groups for one terminal device may be 1 or 2. In some embodiments, for non-slot based uplink and/or downlink transmission with a certain number of symbols, the number of front-loaded DMRS symbols may be limited. For example, for non-slot based transmission with 2, 4 or 7 symbols, the maximum number of front-loaded DMRS symbols for one terminal device may be 1. In some embodiments, for non-slot based uplink and/or downlink transmission with a certain number of symbols, at least one of the CDM groups may be assumed to be absent for rate matching. For example, for non-slot based transmission with 2, 4 or 7 symbols and for DMRS type 1 and/or type 2, if all the configurations are associated with DMRS ports from one CDM group, the other CDM group may be assumed to be absent for rate matching. For example, the REs of the other CDM group can be used for data transmission. For example, for non-slot based transmission with 2, 4 or 7 symbols and for DMRS type 2, if all the configurations are associated with DMRS ports from one or two CDM groups, a third CDM group may be assumed to be absent for rate matching. For example, the REs of the third CDM group can be used for data transmission.

In some embodiments, some parameters in the DMRS configuration for one terminal device may be associated with each other. In some embodiments, if the maximum number of front-loaded DMRSs is 1, the available number of additional DMRSs may be one of {0, 1, 2, 3}. In some embodiments, if the maximum number of front-loaded DMRSs is 2 and the number of additional DMRSs is 0 or 1, configurations in the DMRS configuration table associated with an assumption that the number of front-loaded DMRS symbols is 1 and 2 are available. In some embodiments, if the maximum number of front-loaded DMRSs is 2 and the number of additional DMRSs is 2 or 3, some of the configurations in the DMRS configuration table may be unavailable. For example, the configuration(s) with an assumption that the number of front-loaded DMRS symbols is 2 may be unavailable. In some embodiments, only the available configurations in the DMRS configuration table may be indicated to the terminal device. Specifically, in some embodiments, the available configurations can be re-indexed with new indices. The size of a field in DCI for indicating a specific configuration for DMRS transmission can be determined based on the total number of the available configurations. As such, the size of the filed in DCI for indicating a specific DMRS configuration will be reduced.

In some embodiments, the terminal device 120 may be configured with a complete DMRS configuration table (such as, via RRC signaling). The complete DMRS table may include different DMRS configurations based on various assumptions. For example, an assumption may include at least one of the following: one or more DMRS ports, a scrambling ID of a DMRS sequence, the number of DMRS transmission layers, a DMRS configuration pattern to be used for DMRS transmission, the number of front-loaded DMRS symbols, presence or absence of a CDM group for rate matching, single-user scheduling, multi-user scheduling, single-user and multi-user scheduling, single-panel scheduling, multi-panel scheduling, single-TRP scheduling and multi-TRP scheduling. In some embodiments, the network device 110 may further indicate to the terminal device 120 a new DMRS configuration table (such as, via RRC signaling) which is generated by restricting some configurations in the complete DMRS configuration table. In one embodiment, the indication of the new DMRS configuration table can be a bitmap with respect to the complete DMRS configuration table. In another embodiment, the new DMRS configuration table may include several subsets of the complete DMRS configuration table. For example, if one subset is indicated to one terminal device, all of the configurations in the subset may be available for the terminal device. For example, the indication of the new DMRS configuration table including several subsets can be a bitmap. For example, if a bit is “1”, the corresponding subset is available; while if a bit is “0”, the corresponding subset is unavailable. A specific configuration in the new DMRS configuration table can be then indicated to the terminal device 120 via dynamic signaling (such as, in DCI). In this way, the signaling overhead for indicating a DMRS configuration to the terminal device 120 can be reduced. Specifically, in some embodiments, the configurations in the new DMRS configuration table can be indexed with new indices, which are different from their indices in the complete DMRS table. The size of a field in DCI for indicating a specific configuration for DMRS transmission can be determined based on the total number of configurations included in the new DMRS configuration table. As such, the size of the filed in DCI will be reduced. FIG. 10 shows an example of such embodiment.

In some embodiments, there may be some restrictions on a configuration associated with more than one DMRS transmission layer. For example, in one embodiment, for DMRS type 2, DMRS ports in the DMRS configuration table may all come from up to 2 CDM groups. That is, there may be no configuration associated with each of the 3 CDM groups. For example, in this event, single-TRP or single-panel scheduling can be assumed for the configurations in the DMRS configuration table.

In some embodiments, there may be some restrictions on the number of configurations in the DMRS configuration table. In one embodiment, for DMRS type 1, the maximum number of terminal devices to be co-scheduled may be restricted. For example, there may be maximum 8 terminal devices each with 1 DMRS transmission layer to be co-scheduled. There may be maximum 4 terminal devices each with 2 DMRS transmission layers to be co-scheduled. There may be maximum 3 terminal devices each with 3 DMRS transmission layers to be co-scheduled. There may be maximum 2 terminal devices each with 4 DMRS transmission layers to be co-scheduled. For example, if the number of symbol for front-loaded DMRS is 1, there may be maximum 4 terminal devices each with 1 DMRS transmission layer to be co-scheduled. There may be maximum 2 terminal devices each with 2 DMRS transmission layers to be co-scheduled. There may be no multi-user scheduling if 3 or 4 DMRS transmission layers are configured for one terminal device. In one embodiment, for DMRS type 2, the maximum number of terminal devices to be co-scheduled may be restricted. For example, there may be maximum 8 terminal devices each with 1 DMRS transmission layer to be co-scheduled. There may be maximum 4 or 6 terminal devices each with 2 DMRS transmission layers to be co-scheduled. There may be maximum 4 or 3 terminal devices each with 3 DMRS transmission layers to be co-scheduled. There may be maximum 3 or 2 terminal devices each with 4 DMRS transmission layers to be co-scheduled. It is to be noted that terminal devices with different number of transmission layers still can be co-scheduled. In this way, the number of configurations in the DMRS configuration table can be reduced, thereby reducing the signaling overhead for indicating one thereof

In some embodiments, for example, there may be a parameter configured to the terminal device 120. In this event, if the first configuration is allocated from the DMRS configuration table for the terminal device 120, the first configuration may be combined with the configured parameter to indicate an actual configuration for DMRS transmission to the terminal device 120. In some embodiments, for example, the configured parameter may indicate at least one of the following: a Quasi-Co-Location (QCL) parameter, a scrambling ID of a DMRS sequence, presence or absence of a CDM group for rate matching, UL DMRS CDM group(s) for rate matching, single-TRP or multi-TRP scheduling, and so on. The actual configuration for DMRS transmission may indicate at least one of the following: one or more DMRS ports, a scrambling ID of a DMRS sequence, the number of DMRS transmission layers, a DMRS configuration pattern to be used for DMRS transmission, the number of front-loaded DMRS symbols, presence or absence of a CDM group for rate matching, single-user scheduling, multi-user scheduling, single-user and multi-user scheduling, single-panel scheduling, multi-panel scheduling, single-TRP scheduling and multi-TRP scheduling. Specially, in some embodiments, different configurations or different subsets of configurations from the DMRS configuration table may be associated with different preconfigured parameters, respectively.

In some embodiments, there may be a respective scrambling ID configured for each CDM group. If the respective scrambling IDs for different CDM groups are the same, a first DMRS configuration table may be implicitly indicated. For example, DMRS ports associated with a configuration for at least 2-layer DMRS transmission may come from a same CDM group. If the scrambling IDs of different CDM groups are different, a second DMRS configuration table which is different from the first DMRS configuration table may be implicitly indicated. For example, DMRS ports associated with a configuration for at least 2-layer DMRS transmission may come from different CDM groups.

In some embodiments, the scheduling of single-TRP/single-panel and multi-TRP/multi-panel may be implicitly indicated by some parameters. For example, the parameters may be included in the QCL parameters. In some embodiments, there may be a respective scrambling ID configured for each CDM group. If the respective scrambling IDs for different CDM groups are the same, single-TRP or single-panel transmission may be assumed. If the scrambling IDs of different CDM groups are different, multi-TRP or multi-panel transmission may be assumed.

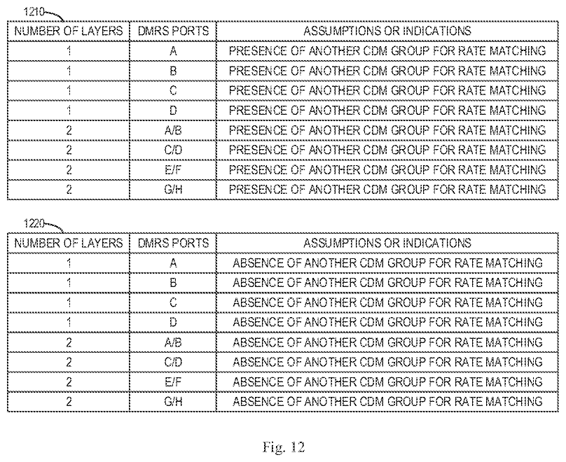

FIG. 11A shows an example of such embodiments. As shown in FIG. 11A, if the respective scrambling IDs for different CDM groups are the same, a DMRS configuration table 1110 may be implicitly indicated. For example, the terminal device 120 may be implicitly indicated that the scheduling is from single TRP/panel. However, if the respective scrambling IDs for different CDM groups are different, another DMRS configuration table 1120 may be implicitly indicated. For example, the terminal device 120 may be implicitly indicated that the scheduling is from multiple TRPs/panels. In the two cases, corresponding DMRS ports may be different, as shown in FIG. 11A.

FIG. 11B shows another example of such embodiments. As shown in FIG. 11B, if the respective scrambling IDs for different CDM groups are the same, a DMRS configuration table 1130 may be implicitly indicated. For example, the terminal device 120 may be implicitly indicated that the scheduling is from one cell (for example, with an even cell ID). However, if the respective scrambling IDs for different CDM groups are different, a DMRS configuration table 1140 may be implicitly indicated. For example, the terminal device 120 may be implicitly indicated that the scheduling is from another cell (for example, with an odd cell ID). In the two cases, corresponding DMRS ports may be different, as shown in FIG. 11B.

In some embodiments, the implicit indication may only effect on a subset of the configuration table. For example, in one embodiment, no matter the respective scrambling IDs for different CDM groups are the same or not, those configurations associated with one DMRS transmission layer may not be changed. In another embodiment, if the respective scrambling IDs for different CDM groups are the same, the X-layer configurations (i.e., configurations associated with X transmission layers) in the DMRS configuration table may be associated with X layers from a same CDM group. However, if the respective scrambling IDs for different CDM groups are different, the X-layer configurations in the DMRS configuration table may be associated with X layers from different CDM groups. For example, X may be any of 2, 3 and 4. In some embodiments, the scrambling ID can be indicated in a QCL parameter.

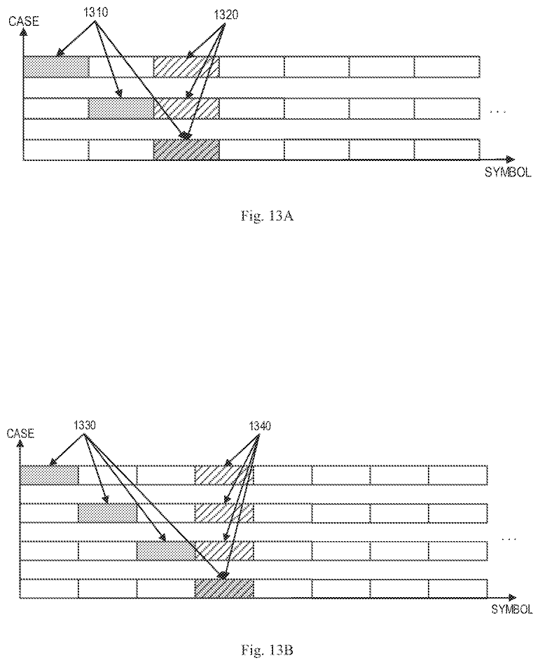

In some embodiments, for DMRS type 1, if the maximum number of front-loaded DMRS symbols is 1, there may be only one set of Modulation and Coding Scheme/New Data Indicator/Redundancy version (MCS/NDI/RV) in DCI. In this case, for example, whether CDM group(s) is present or absent for rate matching may be indicated in the DMRS configuration table. In some embodiments, for DMRS type 1, if the maximum number of front-loaded DMRS symbols is 2, there may be two sets of MCS/NDI/RV in DCI. In this case, for example, for each terminal device in multi-user scheduling, only one codeword (CW) can be supported. As such, NDI of the disabled CW can be used to indicate whether CDM group(s) is present or absent for rate matching at least for some configurations in the DMRS configuration table. FIG. 12 shows an example of such embodiments. As shown in FIG. 12, if NDI of the disabled CW is 0, a configuration table 1210 can be indicated; while if NDI of the disabled CW is 1, a different configuration table 1220 can be indicated.

In some embodiments, for DMRS type 2, there may be one or two CDM groups which are present for rate matching. If the maximum number of front-loaded DMRS symbols is 2, there may be two sets of MCS/NDI/RV in DCI. In this case, for example, for each terminal device in multi-user scheduling, only one CW can be supported. As such, NDI of the disabled CW can be used to indicate whether CDM group(s) is present or absent for rate matching at least for some configurations in the DMRS configuration table. For example, in one embodiment, for some configurations, presence or absence of both of the two CDM groups can be indicated by 1-bit NDI. In another embodiment, one CDM group can be assumed to be present or absent for rate matching and 1-bit NDI can be used to indicate whether the other CDM group is present or absent for rate matching. In addition, in some embodiments, there may be restrictions on the number of DMRS ports and/or CDM groups for one terminal device. For some configurations, one CDM group can be assumed to be present or absent for rate matching and 1-bit NDI can be used to indicate whether the other CDM group is present or absent for rate matching. In another embodiment, each of the two CDM groups can be assumed to be present or absent for rate matching.

In some embodiments, there may be some configurations for DMRS configuration associated with different number of transmission layers. These configurations may be related to a certain condition. If the condition is satisfied, all of these configurations will be available in the DMRS configuration table. However, if the condition is not satisfied, all of these configurations will be unavailable. For example, a configuration associated with 3 transmission layers may be related to DMRS ports A, B and/or C. Another configuration associated with 2 transmission layers may be related to DMRS ports F and/or H. If multi-user scheduling is enabled for multi-TRP/panel transmission, the other configuration associated with DMRS ports F and/or H may be available. However, if multi-TRP/panel transmission is not enabled, the other configuration associated with DMRS ports F and/or H may be unavailable.

As described above, a mixed DL/UL slot can be supported in NR. In a mixed slot, for the location of the first position of the front-loaded DMRS for PUSCH, it has been agreed that the first OFDM symbol with respect to the scheduled data contains the first symbol of front-loaded UL DMRS. It has also agreed that the 3^{rd} or 4^{th} symbol of a slot contains the first symbol of front-loaded DMRS. However, detailed designs for UL DMRS configuration have not been designed yet. In some embodiments, a starting position (also referred to as “a third starting position”) for UL DMRS transmission in the mixed slot can be determined based on a starting position (also referred to as “a first starting position”) for PUSCH transmission and a starting position (also referred to as “a second starting position”) for DL DMRS transmission in the slot.

In one embodiment, if the starting position for DL DMRS transmission is the 3^{rd} symbol in the slot, and the PUSCH transmission starts no later than the 3^{rd} symbol in the slot, the UL DMRS transmission may start from the 3^{rd} symbol in the slot. In another embodiment, if the starting position for DL DMRS transmission is the 4^{th} symbol in the slot, and the PUSCH transmission starts no later than the 4^{th} symbol in the slot, the UL DMRS transmission may start from the 4^{th} symbol in the slot.

FIGS. 13A and 13B show examples of such embodiments. In FIG. 13A, suppose that the starting position 1310 for PUSCH transmission is X (that is, the X^{th} symbol in one slot, where the symbol index starts from 1). In one embodiment, if the starting position for DL DMRS transmission is 3 (that is, the 3^{rd} symbol in one slot) and X<=3, the starting position 1320 for UL DMRS transmission may be 3. In FIG. 13B, suppose that the starting position 1330 for PUSCH transmission is Y (that is, the Y^{th} symbol in one slot, where the symbol index starts from 1). In one embodiment, if the starting position for DL DMRS transmission is 4 (that is, the 4^{th} symbol in one slot) and Y<=4, the starting position 1340 for UL DMRS transmission may be 4.

Additionally, in NR, timing between when the terminal device receives a

QCL configuration and the first time that the QCL configuration is applied for demodulation of PDSCH or PDCCH have been discussed. In case that at least spatial QCL is configured, NR supports the beam indication for PDSCH as follows. If TCI field is present: the TCI field is always present in the associated DCI for PDSCH scheduling irrespective of same-slot scheduling or cross-slot scheduling. If the scheduling offset is less than a threshold K, PDSCH may use a pre-configured/pre-defined/rule-based spatial assumption. If the scheduling offset is not less than the threshold K, PDSCH may use the beam (spatial QCL parameter) indicated by the N-bit TCI field in the assignment DCI.

In some embodiments, the threshold K may be different in different cases. For example, the threshold K may equal to K1 in at least one of the following cases: the beam is changed; the DMRS of PDCCH and the DMRS of scheduled PDSCH is not QCLed; or the TCI indicated in DCI is changed. The threshold K may equal to K2 in at least one of the following cases: the beam is not changed; the DMRS of PDCCH and the DMRS of scheduled PDSCH is QCLed; or the TCI indicated in DCI is changed. In some embodiments, for example, K2<=K1.

In some embodiments, a policy for restricting DMRS configuration as described above can be preconfigured in both the network device 110 and the terminal device 120. That is, the terminal device 120 can determine the detailed DMRS configuration based on the second information (for example, an index from the DMRS configuration table) received from the network device 110 and the preconfigured restriction policy. Therefore, the signaling overhead for indicating the DMRS configuration can be reduced.

In some embodiments, in frequency domain, a RB offset can be used for selecting RB(s) for mapping PTRS. In one embodiment, the RB offset can be determined from at least one of following parameters: a scrambling identity (SCID), a cell identity, and so on. In one embodiment, the RB offset can be explicitly configured by Radio Resource Control (RRC) parameter “PTRS-RB-offset”.

In some embodiments, the selected RB(s) for mapping PTRS may be restricted with a frequency range. In some embodiments, the frequency range may be determined based on PTRS density in frequency domain.

In some embodiments, a parameter associated with the PTRS density in frequency domain may be D, and thus the PTRS density may be 1/D in frequency domain, where D is a positive integer. For example, D may be one of 1, 2, 3, 4, 8 or 16. For example, the PTRS density in frequency domain may indicated that the PTRS occupies one subcarrier (not necessarily in all REs) in at least one of every RB (that is, D=1), every 2^{nd} RB (that is, D=2), every 3^{rd} RB (that is, D=3), every 4^{th} RB (that is, 4), every 8^{th} RB (that is, D=8) or every 16^{th} RB (that is, D=16). In some embodiments, the RB offset of a PTRS port may be determined based on the PTRS density in frequency domain. In one embodiment, the RB offset of a PTRS port may be represented as R mod D, where R is a potential index implicitly derived from one or more parameters (e.g. SCID, Cell ID, etc.). In some embodiments, the RB offset may be no greater than the parameter D associated with the PTRS density in frequency domain. For example, an available value of RB offset X may be an integer, and 0≤X<D. For example, is the PTRS frequency density is 1, there may be no need of the RB offset. Alternatively, the RB offset may be 0. For another example, if the PTRS frequency density is ½, the RB offset may be 0 or 1. For another example, if the PTRS frequency density is ⅓, the RB offset may be one of 0, 1 or 2. For another example, if the PTRS frequency density is ¼, the RB offset may be one of 0, 1, 2 or 3.

In some embodiments, for downlink and/or uplink scheduling, the scheduling may be non-slot based and/or slot-based transmission. The network device 110 may indicate a configuration on at least one of the maximum number of DMRS ports, the maximum number of front-loaded DMRS symbols, the maximum number of CDM group(s), the maximum number of codewords, the number of DMRS ports, the number of front-loaded DMRS symbols, the number of CDM group(s) and the number of codewords to the terminal device 120. In some embodiments, the terminal device 120 may report the desired maximum number of PTRS ports to the network device 110. In some embodiments, the number of available values for the reported maximum number of PTRS ports and/or the size of a field for reporting the desired maximum number of PTRS ports may be different based on the different parameters. For example, for some cases, the available values for reported maximum number of PTRS ports may include 0 and 1. Alternatively, there may be no need to report the maximum number of PTRS ports. These cases can be at least one of the following: the maximum number of codewords is 1; the maximum number of DMRS ports is 4; the maximum number of CDM groups is 1; or the maximum number of front-loaded DMRS symbols is 1 for DMRS type 1.

In some embodiments, the terminal device 120 may report the preferred DMRS layer/port associated with PTRS port(s) to the network device 110. In some embodiments, the number of available values and/or the size of a bit field for reporting an index of the preferred DMRS layer/port may be different based on the different parameters. In some embodiments, the size of the bit field for the index of the preferred DMRS layer/port index may be 2 in at least one of the following cases: the maximum number of codewords is 1; the maximum number of DMRS ports is 4; the maximum number of CDM groups is 1; or the maximum number of front-loaded DMRS symbols is 1 for DMRS type 1. In some other cases, the size of the bit field for the index of the preferred DMRS layer/port may be 3. In some embodiments, the size of the bit field for the index of the preferred DMRS layer/port may depend on the number of DMRS layers/ports indicated in the DMRS configuration table. For example, the size of the bit field for the index of the preferred DMRS layer/port may be [log 2(M)]b, where M is the number of DMRS layer/port indicated in DMRS configuration table. In some embodiments, the actual index of the preferred DMRS layer/port should be restricted within the DMRS layer/port indices included in the DMRS configuration table.

In some embodiments, the network device 110 may indicate information on slot configuration (for example, including at least one of the number of downlink symbols, the number of uplink symbols, the number of unknown symbols, or the number of reserved symbols) to the terminal device 120. The information on slot configuration may be indicated via RRC signaling, MAC CE and/or DCI. In some embodiments, the network device 110 may configure the number of additional DMRSs to the terminal device 120. In some embodiments, for some values of the number of additional DMRSs, the position of the last additional DMRS symbol according to the corresponding DMRS configuration pattern may exceed the last available downlink and/or uplink symbol indicated in the information of the slot configuration. In some embodiments, in this case, the number of additional DMRSs may be reduced such that the last additional DMRS symbol does not exceed the last available downlink and/or uplink symbol. In some embodiments, in this case, the information on slot configuration may be restricted such that the last downlink and/or uplink symbol covers the last additional DMRS. That is, the number of downlink and/or uplink symbols indicated in the information on slot configuration should be great enough to cover the last additional DMRS symbol. As such, the number of possible slot configurations and/or the size of a bit field for indicating one of the possible slot configurations may be reduced.

In some embodiments, at least one of the number of available DMRS ports, the number of available CDM groups, or the number of available DMRS configurations in the DMRS configuration table may be related to the number of co-scheduled DMRS ports and/or CDM groups. For example, for DMRS type 2 with 1 symbol front-loaded DMRS, the number of available DMRS ports may be no greater than 2 if the number of co-scheduled DMRS ports is 4.

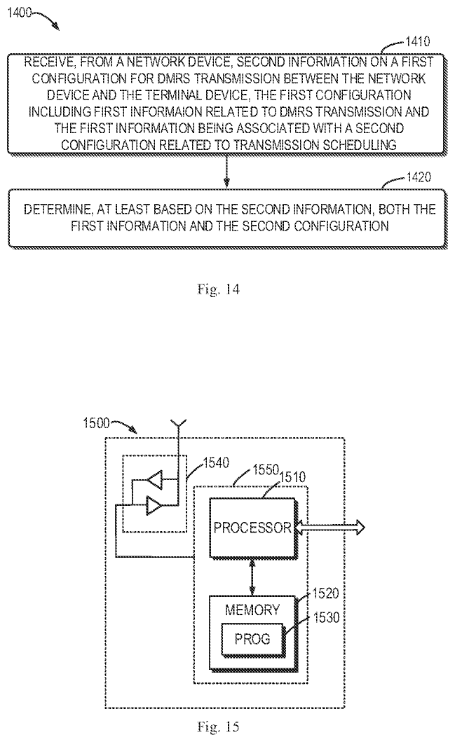

FIG. 14 shows a flowchart of an example method 1400 in accordance with some embodiments of the present disclosure. The method 1400 can be implemented at a terminal device 120 as shown in FIG. 1. For the purpose of discussion, the method 1400 will be described from the perspective of the terminal device 120 with reference to FIG. 1.

In act 1410, the terminal device 120 receives, from the network device 110, second information on a first configuration for DMRS transmission between the network device and the terminal device. In some embodiments, the first configuration may include first information related to the DMRS transmission. The first information may be associated with a second configuration related to transmission scheduling.

In act 1420, the terminal device 120 determines, at least based on the second information, both the first information and the second configuration.

In some embodiments, the first information indicates at least one of the following: one or more DMRS ports, a scrambling identity of a DMRS sequence, the number of DMRS transmission layers, a DMRS configuration pattern to be used for the DMRS transmission and the maximum number of front-loaded DMRS symbols.

In some embodiments, the first information indicates the DMRS configuration pattern and the one or more DMRS ports to be used for the DMRS transmission, the DMRS configuration pattern is associated with at least first and second groups of DMRS ports, the one or more DMRS ports are included in the first group of DMRS ports, and the second configuration indicates whether the second group of DMRS ports are present for rate matching.

In some embodiments, the second configuration further indicates at least one of the following: single-user scheduling, multi-user scheduling, single-user and multi-user scheduling, single-panel scheduling, multi-panel scheduling, single-Transmission and Reception Point (single-TRP) scheduling and multi-Transmission and Reception Point (multi-TRP) scheduling.

In some embodiments, the terminal device 120 may receive the second information by: receiving, via higher layer signaling, a first indication of a plurality of configurations for DMRS transmission between the network device and different terminal devices; and receiving, via dynamic signaling, a second indication of the first configuration.

In some embodiments, the terminal device 120 may determine, based on a preconfigured parameter related to the DMRS transmission and the second information, a third configuration for the DMRS transmission. The third configuration includes the first information and the second configuration.

In some embodiments, the DMRS transmission includes downlink (DL) DMRS transmission from the network device and uplink (UL) transmission from the terminal device, the DL DMRS transmission and the UL DMRS transmission are scheduled in a same slot. The terminal device 120 may further determine a first starting position for Physical Uplink Shared Channel (PUSCH) transmission in the same slot. The terminal device 120 may further determine a second starting position for the DL DMRS transmission in the same slot. In addition, the terminal device 120 may determine, based on the first and second starting positions, a third starting position for the UL DMRS transmission in the same slot.

It is to be understood that at least a part of operations and features related to the network device 110 for restricting DMRS configuration as described above with reference to FIGS. 3-14 are likewise applicable to the method 1400 and have similar effects. For the purpose of simplification, the details will be omitted.

FIG. 15 is a simplified block diagram of a device 1500 that is suitable for implementing embodiments of the present disclosure. The device 1500 can be considered as a further example implementation of a network device 110 or a terminal device 120 as shown in FIG. 1. Accordingly, the device 1500 can be implemented at or as at least a part of the network device 110 or the terminal device 120.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1530 is assumed to include program instructions that, when executed by the associated processor 1510, enable the device 1500 to operate in accordance with the embodiments of the present disclosure. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1510 may form processing means 1550 adapted to implement various embodiments of the present disclosure.

The memory 1510 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1510 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal comprising:
a memory storing a program; and
a hardware processor configured to execute the program stored in the memory to at least:
map a PTRS (Phase Tracking Reference Signal) to a subcarrier using an RB (Resource Block) offset; and
transmit, to a network device, the PTRS mapped to the subcarrier, wherein the RB offset is represented as R mod D, where
the R represents an ID for scrambling, and
the D represents a parameter associated with PTRS frequency density, wherein the D is 2 or 4.

2. A network device comprising:
a memory storing a program; and
a hardware processor configured to execute the program stored in the memory to at least:
receive, from a terminal, a PTRS (Phase Tracking Reference Signal) mapped to a subcarrier; and
assume the subcarrier to which the PTRS is mapped using an RB (Resource Block) offset, wherein
the RB offset is represented as R mod D, where
the R represents an ID for scrambling, and
the D represents a parameter associated with PTRS frequency density, wherein the D is 2 or 4.

3. A method comprising:
mapping a PTRS (Phase Tracking Reference Signal) to a subcarrier using an RB (Resource Block) offset; and
transmitting the PTRS mapped to the subcarrier, wherein
the RB offset is represented as R mod D, where
the R represents an ID for scrambling, and
the D represents a parameter associated with PTRS frequency density, wherein the D is 2 or 4.

4. A method comprising:
receiving a PTRS (Phase Tracking Reference Signal) mapped to a subcarrier; and
assuming the subcarrier to which the PTRS is mapped using an RB (Resource Block) offset, wherein
the RB offset is represented as R mod D, where
the R represents an ID for scrambling, and
the D represents a parameter associated with PTRS frequency density, wherein the D is 2 or 4.
